(19) United States
(12) Patent Application Publication
(10) Pub. No.: US 2010/0088977 A1
(43) Pub. Date: Apr. 15, 2010

(54) APPARATUS AND METHOD FOR FINISHING A WALL SURFACE

(76) Inventor: Curtis William Darling, Freeburg, IL (US)

Correspondence Address: Patent Docket Department;Armstrong Teasdale LLP, One Metropolitan Square, Suite 2600, St. Louis, MO, 63102-2740, US

(21) Appl. No.: 12/250,988

(22) Filed: Oct. 14, 2008

(51) Int. Cl. E04F 19/02; E06B 1/32; E06B 1/00; E04B 1/32

(52) U.S. Cl. 52/86; 52/745.15; 52/211

(57) ABSTRACT

A method and system finish member for forming a wall surface is provided. The finish member comprises a substantially organic material having a length along a longitudinal axis and a thickness perpendicular to the longitudinal axis and the finish member is flexible along the length in a direction of the thickness.

### BACKGROUND OF THE INVENTION

This invention relates generally to wood frame and metal frame construction and, more particularly, to an apparatus and a method for finishing a wall surface used in wood frame and metal frame construction.

At least some known methods of constructing walls and barriers or half walls includes the use of inorganic wallboard panels or sheets, such as gypsum wallboard (GWB), sometimes referred to as “wallboard,” “drywall,” or “plasterboard.” Walls and ceilings made with gypsum wallboard panels are conventionally constructed by securing the wallboard panels to structural members, for example vertically and horizontally oriented pieces of steel or wood such as “studs.” Because wallboard is typically supplied in standard-sized sheets or panels, when forming a wall from the sheets or panels, there will generally be a number of joints between adjacent sheets. In most wallboard construction, these joints are filled and coated with wallboard tape and an adhesive material called joint compound so that the wall will have a monolithic finish.

Generally, wallboard is conventionally produced by enclosing a core containing an aqueous slurry of calcium sulfate hemihydrate (e.g., calcined gypsum) between two large sheets of board cover paper. The calcined gypsum forming the core between the two cover sheets is allowed to set (react with water from the aqueous slurry). The continuously-produced board may then be cut into panels of a desired length (for example, eight feet). After the core has set and is dried, the sandwich becomes a strong, rigid, fire-resistant building material called gypsum drywall.

Gypsum drywall can be used to form almost any cylindrically curved surface. Standard half-inch drywall can be bent around curved framing to a radius as small as 10 feet, as long as the panels are installed with their long edges perpendicular to framing members that are spaced not more than six inches on center. The five-eights-inch panels can bend to a fifteen-foot radius; three-eights-inch panels to a seven foot, six-inch radius; five-sixteenths-inch panels to a six-foot, three-inch radius; and quarter-inch panels to a five-foot radius. Drywall can be bent to tighter curves than listed above by wetting the paper backing, or wetting the front and back paper. However extreme care must be used to avoid damaging or breaking the drywall panel. Additionally, wet drywall is very prone to the growth of mold. When wetting drywall, it is imperative to use plenty of airflow to dry the boards completely after installation.

For very tight curves, for example, to finish off a traditional arch window or doorway, the back of the panel may be scored width-wise to give it more flexibility. These scores are called “kerfs” and they cut through the “back” of the drywall, which makes it much more flexible. A utility knife is used to make parallel cuts from edge to edge, spaced approximately one inch apart. The core is then purposely broken at the cuts to create a flexible length of drywall. However, the only support for the drywall panel is the paper backing, making the scored and broken panel flimsy and easy for the paper to rip and destroy the panel during handling and/or installation.

Aside from standard gypsum board, also available are special flexible panels that can bend to much tighter radii. These ¼-inch panels are usually installed in double layers and can achieve a radius as small as 12 inches.

In frame construction a wood frame wall is built using relatively rough lumber and the interior surface of the wall is finished with GWB. In the event that the wall has a window opening, a window frame is installed with the inner face of the window frame offset outward from the interior of the wall. The return surfaces, which surrounding the window opening and are perpendicular to the interior of the wall, may be finished using either wood wrap and drywall or GWB wrap. Using the drywall wrap technique, GWB is attached to the upper and lower horizontal return portions and to the vertical return portions and suitable reinforcing corner beading is installed to protect the corner transition between the vertical wall and the return surfaces bounding the window opening. Round, arched, and half arch windows present a special problem in that the return surfaces are arcuate and have a bend radius that is less than can be achieved by GWB without using labor intensive and error prone techniques to make the GWB more flexible.

The upper surface of a half wall may also be formed having an arcuate surface to create many types of desired aesthetic effects. In many cases a monolithic wall surface complementary to the vertical surfaces of the wall are desired, in which case the cap of the wall requires a surface treatment similar to that of a circular or arched window or an arched doorway. Using GWB increases the amount of labor required to score the backside of the GWB panels or to wet and then thoroughly dry the GWB to attempt to bend it into conformity with the arcuate surface.

### BRIEF DESCRIPTION OF THE INVENTION

In one embodiment, a finish member portion of a wall surface comprising a substantially organic material and having a length along a longitudinal axis and a thickness perpendicular to the longitudinal axis wherein the finish member is flexible along the length in a direction of the thickness.

In another embodiment, a method of forming a surface of a wall that includes a plurality of drywall members rigidly coupled to framing members wherein the method includes providing a finish member having a thickness substantially equal to a thickness of at least one of the plurality of drywall members, bending the finish member to conform to an area of the wall having an arcuate surface, and coupling the finish member to a framing member defining the arcuate surface.

In yet another embodiment, a wall surface includes a plurality of gypsum-based drywall members rigidly coupled to a plurality of framing members defining a wall, and a finish member including a substantially organic material coupled to one or more of the plurality of framing members that define an arcuate portion of the wall wherein the finish member has a length along a longitudinal axis and a thickness perpendicular to the longitudinal axis and wherein the finish member includes a bend radius along the length in a direction of the thickness of less than ten feet.

### BRIEF DESCRIPTION OF THE DRAWINGS

FIGS. 1-5 show exemplary embodiments of the apparatus and method described herein.

FIG. 1 is a perspective view of a finish member for forming a wall surface in accordance with an exemplary embodiment of the present invention;

FIG. 2 is a perspective view of an arched doorway formed using the finishing member shown in FIG. 1;

FIG. 3 is a perspective view of a circular window formed using the finishing member shown in FIG. 1;

FIG. 4 is a perspective view of a curved half wall formed using the finishing member shown in FIG. 1; and

FIG. 5 is a flow diagram of a method of forming a surface of a wall wherein the wall includes a plurality of drywall members rigidly coupled to framing members.

### DETAILED DESCRIPTION OF THE INVENTION

The following detailed description illustrates embodiments of the invention by way of example and not by way of limitation. It is contemplated that the invention has general application in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

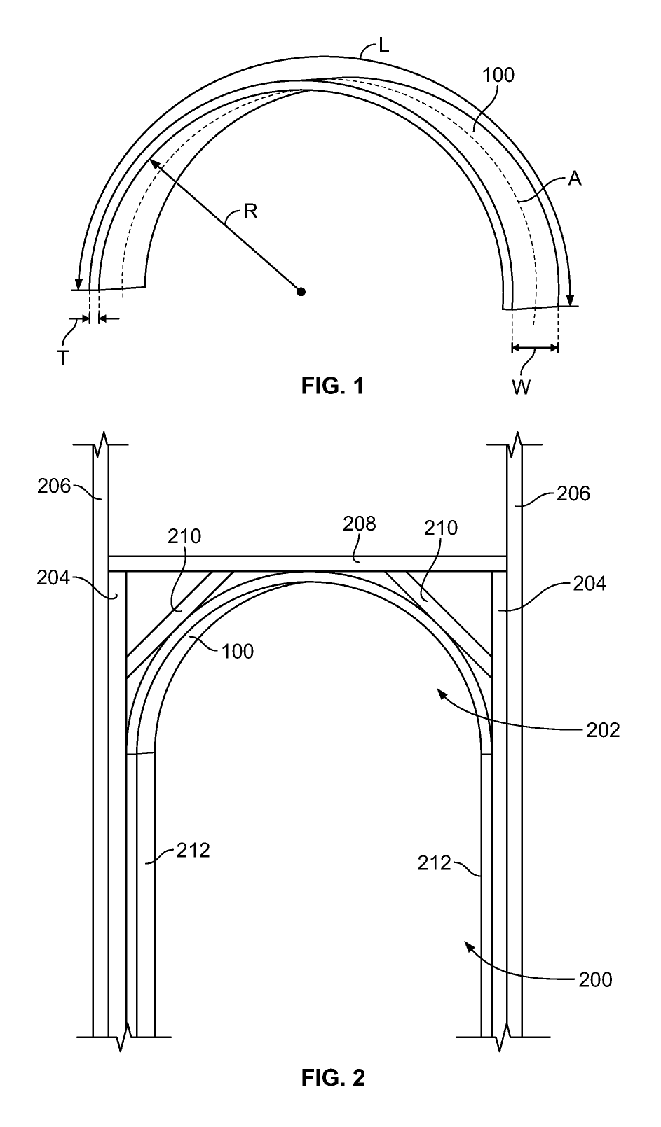

FIG. 1 is a perspective view of a finish member 100 for forming a wall surface (not shown in FIG. 1) in accordance with an exemplary embodiment of the present invention. In the exemplary embodiment, finish member 100 comprises a substantially organic material, for example, but not limited to vinyl monomers and vinyl polymers, recycled plastic material, post-industrial remnant vinyl. Finish member 100 is substantially gypsum-free and may include a matrix or web internal to finishing member 100 to improve strength characteristics of finishing member 100. Finish member 100 has a length L along a longitudinal or centerline axis A, a width W, and a thickness T perpendicular to axis A. Thickness T represents a thickness of a single ply of non-laminate finishing member 100. In the exemplary embodiment, thickness T is one-half inch, which is a typical thickness for gypsum wallboard generally used in construction. Finish member 100 is flexible along length L in a direction of thickness T. As used herein, flexible is used to indicate a modulus of elasticity of a material that permits a one-half inch thick member formed of the material to bend to a radius of less than five feet, for example, three feet. Such a bend radius is attainable without wetting the material, scoring the material, or applying several plies or laminations of members thinner than one-half inch. Accordingly, finish member 100 can be manipulated to bend about a radius R. Typical GWB can only accommodate a bend radius of approximately ten feet without scoring, wetting, or using multiple thinner plies in a laminate configuration. However, in the exemplary embodiment, finishing member 100 is capable of a bend radius of less than ten feet based on the formulation of the material of fabrication and the forming process. In one embodiment finishing member is capable of a bend radius of five feet and in another embodiment, finishing member 100 is capable of a bend radius of three feet. Finish member 100 is formed having a first modulus of elasticity, finish member 100 is configured to be coupled in a position to form the wall surface having at least one of a convex and a concave bend while maintaining the first modulus of elasticity. Accordingly, labor intensive and time consuming efforts to improve the flexibility of finish member 100 such as scoring, wetting, or using multiple thinner plies are not needed to conform finishing member 100 to relatively tight bend radii.

FIG. 2 is a perspective view of an arched doorway formed using finishing member 100 (shown in FIG. 1). In the exemplary embodiment, an opening 200 within which an arch 202 is to be formed is defined by a pair of trimmers 204 nailed to respective king studs 206 and at the top by a header 208. One or more corner braces 210 are nailed between header 208 and trimmers 204 to roughly define the desired arch opening. Finishing member 100 is positioned and coupled to trimmers 204, header 208, and corner braces 210 using for example, but not limited to nails, screws, and adhesive. Joint compound may then be applied directly to finishing member 100 to finish the arch. Finishing member 100 has a surface texture that readily accepts joint compound and provides a rough surface such that joint compound adheres to finishing member 100 without additional surface preparation. Corner bead may be applied directly to GWB members 212 and finishing member 100 to form a monolithic arch doorway surface. In the case of metal frame construction, finishing member 100 may be coupled with self tapping speed screws, rather than nails as used in wood frame construction.

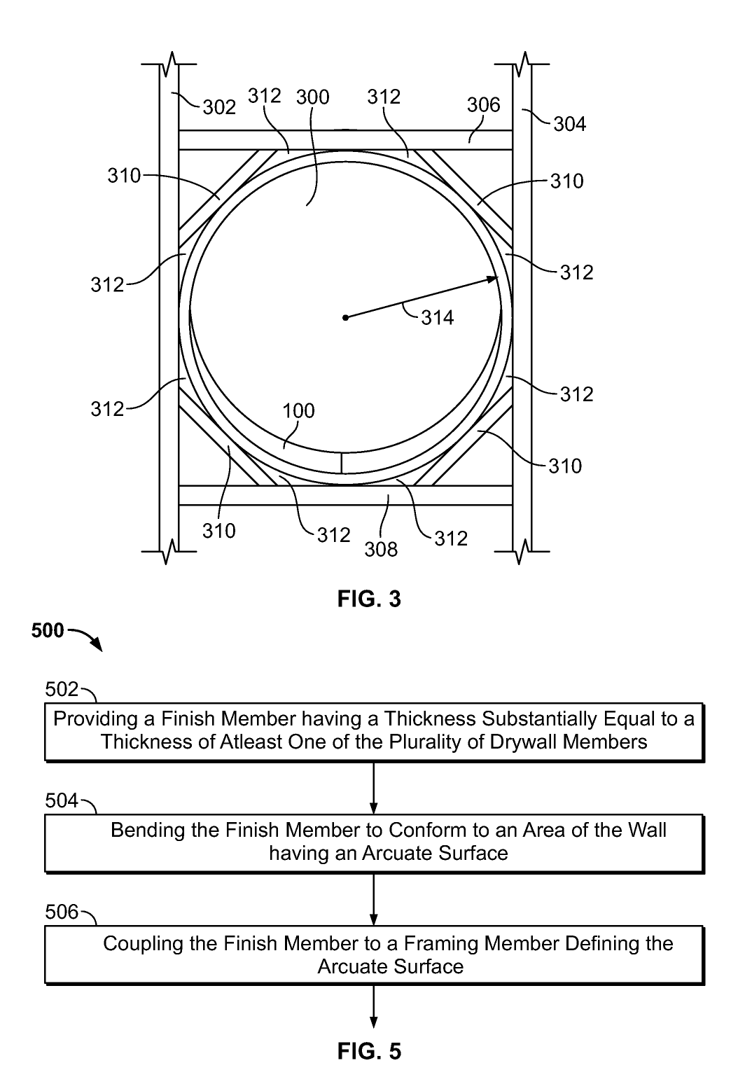

FIG. 3 is a perspective view of a circular window formed using finishing member 100 (shown in FIG. 1). In the exemplary embodiment, an opening 300 within which a circular window will be installed is defined by a pair of studs 302 and 304, a header 306, a sill 308, and one or more corner braces 310. Finishing member 100 is positioned in the return of window opening 300 and coupled to studs 302 and 304, header 306, sill 308, and corner braces 310 using for example, but not limited to nails, screws, and adhesive. Joint compound may then be applied directly to finishing member 100 to finish the window return. A wood or laminate backing is not needed to provide support for finishing member 100 over gaps between header 306 and corner braces 310, studs 302 and 304 and corner braces 310, and sill 308 and corner braces 310 due to the strength of finishing member 100. Finishing member 100 has a surface texture that readily accepts joint compound and provides a rough surface such that joint compound adheres to finishing member 100 without additional surface preparation. Corner bead may be applied directly to finishing member 100. Finishing member 100 permits finishing a window return having a bend radius of less than three feet with a single member that does not require wetting, scoring, or installation in a plurality of thinner plies stacked together to achieve a thickness of standard GWB.

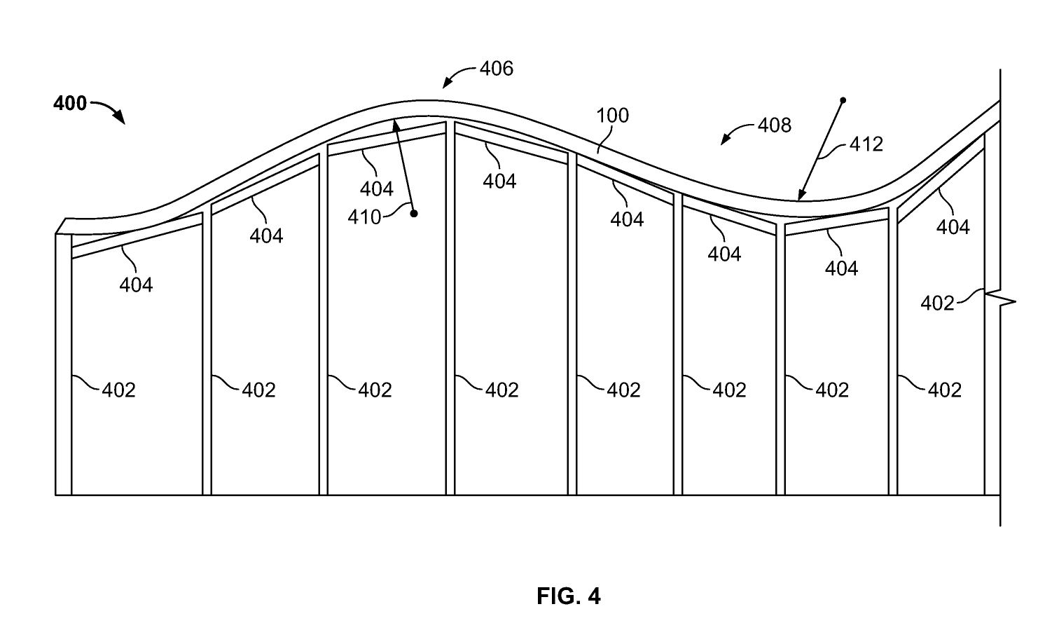

FIG. 4 is a perspective view of a curved half wall 400 formed using finishing member 100 (shown in FIG. 1). In the exemplary embodiment, a half wall is framed using a plurality of studs 402 and a plurality of stringers 404 fastened in place between adjacent pairs of studs 402. Finishing member 100 is positioned on an upper surface of the framed half wall 400 and coupled to studs 402 and/or stringers 404 using for example, but not limited to nails, screws, and adhesive. Joint compound may then be applied directly to finishing member 100 to finish half wall 400. A wood or laminate backing is not needed to provide support for finishing member 100 over gaps above stringers 404 between studs 402 due to the strength of finishing member 100. Finishing member 100 has a surface texture that readily accepts joint compound and provides a rough surface such that joint compound adheres to finishing member 100 without additional surface preparation. Corner bead may be applied directly to finishing member 100. Finishing member 100 can be bent in a convex curve 406 as well as a concave curve 408 to accommodate the contour of half wall 400. Curves 406 and 408 may have bend radii 410, 412 of less than three feet without wetting, scoring, or install a plurality of thinner plies stacked together to achieve a thickness of standard GWB.

FIG. 5 is a flow diagram of a method 500 of forming a surface of a wall wherein the wall includes a plurality of drywall members rigidly coupled to framing members. In the exemplary embodiment, method 500 includes providing 502 a finish member having a thickness substantially equal to a thickness of at least one of the plurality of drywall members, bending 504 the finish member to conform to an area of the wall having an arcuate surface, and coupling 506 the finish member to a framing member defining the arcuate surface.

The above-described embodiments of an apparatus and a method for forming an arcuate wall surface provide a cost-effective and reliable means frame construction. More specifically, the methods and systems described herein facilitate finishing arched windows and doorways, circular windows, and “drywall art” features in walls. As a result, the apparatus and method described herein facilitate wall finishing in a cost-effective and reliable manner.

While the disclosure has been described in terms of various specific embodiments, it will be recognized that the disclosure can be practiced with modification within the spirit and scope of the claims.

What is claimed is:

1. A finish member portion of a wall surface, said finish member comprising a substantially organic material, said finish member having a length along a longitudinal axis and a thickness perpendicular to the longitudinal axis, said finish member is flexible along the length in a direction of the thickness.

2. A finish member in accordance with claim 1 wherein said finish member comprises a single ply having a thickness greater than one-quarter inch and a bend radius of less than ten feet.

3. A finish member in accordance with claim 1 wherein said finish member comprises a bend radius less than five feet.

4. A finish member in accordance with claim 1 wherein said finish member comprises a bend radius less than three feet.

5. A finish member in accordance with claim 1 wherein said finish member comprises a first modulus of elasticity when formed, said finish member configured to be coupled in a position to form the wall surface having at least one of a convex and a concave bend while maintaining the first modulus of elasticity.

6. A finish member in accordance with claim 1 wherein said finish member is flexible without scoring a surface of the finish member or wetting the finish member to increase a flexibility of the finish member.

7. A finish member in accordance with claim 1 wherein said finish member comprises at least one of vinyl monomers and vinyl polymers.

8. A finish member in accordance with claim 1 wherein said finish member comprises recycled plastic material.

9. A finish member in accordance with claim 1 wherein said finish member comprises post-industrial remnant vinyl.

10. A finish member in accordance with claim 1 wherein said finish member is substantially gypsum-free.

11. A finish member in accordance with claim 1 wherein said finish member is non-laminate.

12. A method of forming a surface of a wall comprising a plurality of drywall members rigidly coupled to framing members, said method comprising:
providing a finish member having a thickness substantially equal to a thickness of at least one of the plurality of drywall members;
bending the finish member to conform to an area of the wall having an arcuate surface; and
coupling the finish member to a framing member defining the arcuate surface.

13. A method in accordance with claim 12 wherein bending the finish member comprises bending the finish member without scoring or wetting the finish member to facilitate bending the finish member without breaking.

14. A method in accordance with claim 12 wherein providing a finish member comprises providing a finish member comprising substantially organic material.

15. A method in accordance with claim 12 wherein providing a finish member comprises providing a finish member having a length along a longitudinal axis and a thickness perpendicular to the longitudinal axis and wherein the finish member is flexible along the length in a direction of the thickness.

16. A method in accordance with claim 12 further comprising applying a coating of joint compound over an exposed surface of the finish member, said coating extending onto at least one of the plurality of drywall members and into a joint defined between the finish member and the at least one of the plurality of drywall members to generate a monolithic wall surface.

17. A wall surface comprising:
a plurality of gypsum-based drywall members rigidly coupled to a plurality of framing members defining a wall; and
a finish member comprising a substantially organic material coupled to one or more of the plurality of framing members that define an arcuate portion of the wall, said finish member having a length along a longitudinal axis and a thickness perpendicular to the longitudinal axis, said finish member having a bend radius along the length in a direction of the thickness of less than ten feet.

18. A wall surface in accordance with claim 17 wherein the arcuate portion of the wall defines at least one of an arch of a doorway, an arcuate return of a window, and a cap of a half-wall.

19. A wall surface in accordance with claim 17 wherein the arcuate portion of the wall includes a bend radius of less than five feet.

20. A finish member in accordance with claim 17 wherein said finish member is flexible without scoring a surface of the finish member or wetting the finish member to increase a flexibility of the finish member.

21. A finish member in accordance with claim 17 wherein said finish member is non-laminate.
